(19) United States
(12) Patent Application Publication
(10) Pub. No.: US 2025/0390585 A1
(43) Pub. Date: Dec. 25, 2025

(54) VEHICLE USB FUZZING METHOD AND APPARATUS

(71) Applicant: Autocrypt Co., Ltd., Seoul (KR)

(72) Inventors: Eui Seok KIM, Seoul (KR); Duk Soo KIM, Seoul (KR); Sang Gyoo SIM, Seoul (KR); Ki Ho JOO, Seoul (KR); Jong Guk LEE, Suwon-si (KR); Hee Teak MOON, Incheon (KR); Hyung Uk KIM, Incheon (KR); Sung Kyoon CHUNG, Asan-si (KR); Jong Hyuk SONG, Incheon (KR); Eun Tae JANG, Incheon (KR); Dong Hyeon JEONG, Seoul (KR)

(21) Appl. No.: 19/242,437

(22) Filed: Jun. 18, 2025

(30) Foreign Application Priority Data
Jun. 20, 2024 (KR) 10-2024-0080267

(51) Int. Cl. G06F 21/57; H04W 4/48

(52) U.S. Cl. CPC G06F 21/577; G06F 2221/033; H04W 4/48

(57) ABSTRACT

A vehicle USB fuzzing method by a vehicle USB fuzzing apparatus connected to an in-vehicle infotainment (IVI) device comprises: generating malicious files by mutating a seed file; mounting the apparatus to the vehicle so the IVI device or head unit controller recognizes the malicious files; transmitting a predetermined number of malicious files to the vehicle; unmounting the apparatus after transmission; monitoring the kernel log generated in the apparatus while the malicious media files are replayed or attempted to be replayed in the vehicle; checking for errors in USB-related logs; and determining the fuzzing result based on the presence of such errors.

### CROSS-REFERENCE TO RELATED APPLICATIONS

This application claims priority to Korean Patent Applications No. 10-2024-0080267, filed on Jun. 20, 2024, with the Korean Intellectual Property Office (KIPO), the entire contents of which are hereby incorporated by reference.

### BACKGROUND

### 1. Technical Field

Exemplary embodiments of the present disclosure relate to vehicle universal serial bus (USB) fuzzing, and more specifically, to a method and apparatus for performing direct fuzzing on an electrical component through a USB port to discover security vulnerabilities in an application installed on an electrical component or a kernel area of an electronic control unit in a vehicle.

### 2. Related Art

As the electrification of vehicle components progresses rapidly, the types and number of electrical components mounted on vehicles, such as electronic control units (ECUs), are increasing significantly. Electrical components are mainly classified as a power train control system, a body control system, a chassis control system, a vehicle network, and a multimedia system.

Here, the power train control system includes an engine control system, an automatic transmission control system, and the like. The body control system includes a body electrical equipment control system, a convenience device control system, a lamp control system, and the like. The chassis control system includes a steering control system, a brake control system, a suspension control system, and the like. The vehicle network includes a controller area network (CAN), a FlexRay-based network, a media oriented system transport (MOST)-based network, and the like. The multimedia system includes a navigation system, a telematics system, an infotainment system, and the like.

Such vehicle systems or ECUs mounted on each system are connected to each other through a vehicle network, and a vehicle network such as a CAN capable of smoothly supporting functions of each device is required even when problems of the ECUs themselves or crashes between the ECUs occur. The CAN may support a transmission rate of up to 1 Mbps and may support automatic retransmission of crashed frames and error detection based on a cycle redundancy interface (CRC), or the like.

Recently, a frequency of cases in which in-vehicle CANs are exploited for automobile hacking techniques has been increased. That is, an attacker stops a vehicle, opens or locks doors or windows at will, or turns a radio on or off at will by manipulating a specific ECU connected to a CAN which is a communication network that connects components in a vehicle.

Meanwhile, a fuzz test performed in the automobile industry is a test that induces errors by transmitting malformed data to an ECU of a vehicle or an application mounted on the ECU. For example, fuzz testing is performed to find security vulnerabilities by repeatedly inputting random data into software installed on an ECU of a vehicle to induce systematic failures. By using such fuzz testing, the security vulnerabilities of a vehicle may be checked in advance through static analysis and/or dynamic analysis, and based on the discovered security vulnerabilities, a security process may be updated or a new security process may be developed.

In a current fuzzing process in the automobile industry, first, a media file of an incorrect format is generated using a fuzzer. The media file is copied to an external storage device such as a universal serial bus (USB) memory stick or a portable storage device. Then, when a tester inserts a USB memory stick into a USB port of a vehicle, a media player of the vehicle replays the media files in the USB memory stick. In this case, the tester observes whether the media player or an ECU of the vehicle generates an error or stops when the media player replays or attempts to replay the media file.

However, there are various limitations in a procedure of fuzzing existing vehicle infotainment systems for a vehicle and applications installed thereon. For example, only application-level fuzzing is possible for applications such as media players, and operating system-level kernel fuzzing is impossible. In addition, to detect a success of fuzzing of malfunctions, failures, or the like of electronic devices, a tester should stays in a vehicle during a fuzzing process to continuously observe the state of a media player. Moreover, since a media player can play only a limited number of files at a time, it is not possible to fuzz a large number of files at a time, and a tester should manually repeat a process of continuously generating files, transferring the files, and connecting the files to a vehicle whenever a fuzz test is performed.

Accordingly, there is a need for a new vehicle fuzzing method capable of reducing limitations of current fuzz testing performed in a vehicle to discover security vulnerabilities in an in-vehicle infotainment device or an ECU.

### SUMMARY

Accordingly, example embodiments of the present invention are provided to substantially obviate one or more problems due to limitations and disadvantages of the related art.

Accordingly, example embodiments of the present disclosure are provided to provide a vehicle universal serial bus (USB) fuzzing method and apparatus device that are capable of fuzzing an in-vehicle infotainment (IVI) device or an electronic control unit by automatically and directly transmitting a malformed file to a vehicle connected through a USB.

Another example embodiments of the present disclosure are provided to a vehicle USB fuzzing method and apparatus that are capable of effectively fuzzing not only an application level area of an electrical component of a vehicle, such as a media player, but also a kernel driver area of the electrical component.

Still another example embodiments of the present disclosure are provided to provide a vehicle USB fuzzing method and apparatus by which, by directly connecting a fuzzer and a USB port of a vehicle, an automatically generated malicious file may be directly transmitted to the vehicle, the fuzzer may automatically determine the success or failure of fuzzing, and a log caused by an error operation of an electrical component or an electronic control unit of the vehicle may be effectively and automatically detected for fuzzing the vehicle.

According to a first exemplary embodiment of the present disclosure, a vehicle universal serial bus (USB) fuzzing method, performed by a vehicle USB fuzzing apparatus connected to an in-vehicle infotainment (IVI) device through a USB, may comprise: mutating a seed file in the vehicle USB fuzzing apparatus and generating malicious files; performing mounting on the vehicle so that a head unit controller of the vehicle or an application of the IVI device recognizes the malicious files; when the vehicle USB fuzzing apparatus is connected to the vehicle through the mounting, transmitting a predetermined number of the malicious files to the vehicle using a transmitter; when the transmitting of the malicious files is completed, performing unmounting to disconnect the vehicle USB fuzzing apparatus from the vehicle; monitoring a kernel log caused by the vehicle and generated in the vehicle USB fuzzing apparatus while media files, which are the malicious files, replay or are attempted to replay in the vehicle; checking whether an error appears in a USB-related log in the monitoring of the kernel log; and determining a success or failure of fuzzing based on the error of the USB-related log.

The generating of the malicious files may include randomly selecting several bits of the seed file and reversing the selected bits to generate the malicious files.

The several bits may be bits in a range of 1% to 5% of all bits of each seed file.

The generating of the malicious files may be performed to not change a file signature portion of the malicious file.

The performing of the mounting on the vehicle may include mounting a folder storing the malicious files on the vehicle as a USB storage.

The vehicle USB fuzzing method may further comprise, when replaying of all of the malicious files in the folder is completed, unmounting the folder.

The vehicle USB fuzzing method may further comprise collecting the seed file, wherein the collecting of the seed file includes collecting a prestored reproduction code from a preset website or a preset address on a network.

The kernel log generated in the vehicle USB fuzzing apparatus may be a mounting failure log of the head unit controller of the vehicle or the IVI device with respect to the malicious file.

The USB-related log may be related to a log of the head unit controller of the vehicle, a log of the head unit controller of the vehicle when a kernel of the IVI device crashes, or a log regarding the IVI device being rebooted.

According to a second exemplary embodiment of the present disclosure, a vehicle universal serial bus (USB) fuzzing method, performed by a vehicle USB fuzzing apparatus connected to an in-vehicle infotainment (IVI) device through a USB cable, may comprise: mutating a system call message in the vehicle USB fuzzing apparatus and generating malicious files; transmitting a predetermined number of the malicious files to a vehicle using a transmitter; monitoring a kernel log caused by a USB device driver of an infotainment controller of the vehicle due to the malicious files and stored in the vehicle USB fuzzing apparatus; checking whether an error appears in a kernel area-related log in the monitoring of the kernel log; and determining a success or failure of fuzzing of a kernel area of an infotainment device or an electronic control unit of the vehicle based on the error in the kernel area-related log.

According to a third exemplary embodiment of the present disclosure, a vehicle universal serial bus (USB) fuzzing apparatus connected to an in-vehicle infotainment (IVI) device through a USB cable may comprise: an input generator configured to mutate a seed file in the vehicle USB fuzzing apparatus and generating malicious files; a transmitter configured to transmit a predetermined number of the malicious files to a vehicle; and a result checker configured to monitor a kernel log caused by the vehicle due to the malicious files and stored in the vehicle USB fuzzing apparatus, check whether an error appears in the monitoring of the kernel log, and determine a success or failure of fuzzing based on the error.

The input generator may randomly select several bits of the seed file and reverse the selected bits to generate the malicious files.

The several bits may be bits in a range of 1% to 5% of all bits of each seed file.

The input generator may perform the mutation to not change a file signature portion of the malicious file.

The vehicle USB fuzzing apparatus may further comprise a mount manager configured to perform mounting on the vehicle so that a head unit controller of the vehicle or an application of the IVI device recognizes the malicious files.

The mount manager may cause a folder storing the malicious files to be mounted on the IVI device of the vehicle as a USB storage.

The mount manager may unmount the folder when the transmission of the malicious file is completed or when replaying of all of the malicious files in the folder is completed.

The input generator may further include a crawler configured to collect a prestored reproduction code from a preset website or a preset address on a network.

The kernel log generated in the vehicle USB fuzzing apparatus may be a mounting failure log of a head unit controller of the vehicle or the IVI device with respect to the malicious file.

The seed file may include a system call message, and the kernel log may include a log of a head unit controller of the vehicle, a log of the head unit controller of the vehicle that occurs when a kernel of the IVI device crashes, or a log regarding the IVI device being rebooted.

According to the present disclosure, there can be provided a vehicle USB fuzzing technique for directly transmitting a malformed file or a malicious file to a vehicle through a USB port of an in-vehicle infotainment (IVI) device.

In addition, according to the present disclosure, there can be provided a new vehicle USB fuzzing method and apparatus that are capable of fuzzing not only an application of an electrical component of a vehicle, such as a vehicle media player, but also a USB kernel area of the electrical component.

In addition, according to the present disclosure, since a fuzzer and a USB port of a vehicle are directly connected through a USB cable or the like, a malicious file can be automatically and directly transferred from the fuzzer to the vehicle, thereby omitting an action of a tester to transfer the malicious file. The fuzzer can automatically determine the success or failure of fuzzing through a kernel log generated in the fuzzer, and furthermore, an error or failure detected during a process of fuzzing an electrical component of the vehicle can be effectively and automatically detected without an operator who performs fuzz testing needing to remain in the vehicle.

### BRIEF DESCRIPTION OF DRAWINGS

FIG. 1 is a block diagram illustrating a structure and operating principle of a vehicle universal serial bus (USB) fuzzing apparatus according to one embodiment of the present disclosure.

FIG. 2 is a block diagram illustrating a structure of another input generator that may be adopted in the vehicle USB fuzzing apparatus of FIG. 1.

FIG. 3 is a flowchart of a vehicle USB fuzzing method according to another embodiment of the present disclosure.

FIG. 4 is a schematic diagram of a structure of a vehicle USB fuzzing apparatus according to still another embodiment of the present disclosure.

FIG. 5 is an exemplary diagram of a fuzzer log that may be used in the vehicle USB fuzzing apparatus of FIG. 4.

FIG. 6 is an exemplary diagram of a diagnostic message (dmesg) log that may be used in the vehicle USB fuzzing apparatus of FIG. 4.

FIG. 7 is a schematic block diagram of a structure of a vehicle USB fuzzing apparatus according to still another embodiment of the present disclosure.

FIG. 8 is a schematic block diagram of a part of a structure of a vehicle USB fuzzing apparatus according to yet another embodiment of the present disclosure.

FIG. 9 is a schematic block diagram of a part of a structure of a vehicle USB fuzzing apparatus according to yet another embodiment of the present disclosure.

### DETAILED DESCRIPTION OF THE EMBODIMENTS

While the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, “at least one of A and B” may refer to “at least one A or B” or “at least one of one or more combinations of A and B”. In addition, “one or more of A and B” may refer to “one or more of A or B” or “one or more of one or more combinations of A and B”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present disclosure will be described in greater detail with reference to the accompanying drawings. In order to facilitate general understanding in describing the present disclosure, the same components in the drawings are denoted with the same reference signs, and repeated description thereof will be omitted.

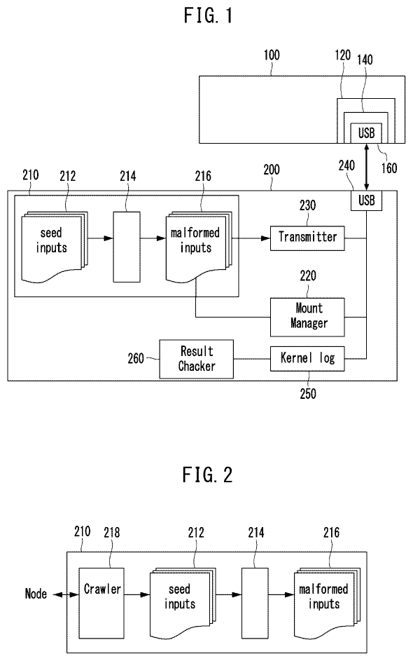

FIG. 1 is a block diagram illustrating a structure and operating principle of a vehicle universal serial bus (USB) fuzzing apparatus according to one embodiment of the present disclosure.

Referring to FIG. 1, a vehicle USB fuzzing apparatus 200 includes an input generator 210, a mount manager 220, a transmitter 230, a USB interface 240, a kernel log storage unit 250, and a result checker 260 to perform fuzzing on a head unit 120 of a vehicle 100 or a media player 140 mounted on the head unit 120 at an application level and/or a kernel level. The vehicle USB fuzzing apparatus 200 may be connected to a USB port 160 mounted on the head unit 120 of the vehicle 100 through a USB cable or the like during fuzzing.

Describing each component in more detail, the input generator 210 may include a seed input storage unit 212 that stores a seed input, a mutator 214, and a malformed-input storage unit 216 that stores a malformed input. The input generator 210 may generate a malformed input by mutating seed inputs through the mutator 214. The mutator 214 may select a seed input, may randomly select one or more bits of the seed input, and may reverse and mutate the selected bits. A seed input may be referred to as a normal file or seed file, and a malformed input may be referred to as a malformed file or malicious file.

The mutator 214 may be configured to not change a file signature portion of the seed input when the seed input is mutated. The reason why the file signature portion of the seed input is not changed is that some vehicle media players will not try to replay a media file when a media file to be replayed is changed too much, in particular, when a file signature portion is changed.

Media players mounted on vehicles may support different media file formats according to vehicles. For example, Renault vehicles support MP3, WMA, OGG, and FLAG formats, Volkswagen vehicles support MP3, WMA, ACC, FLAC, and WAV formats, and GM vehicles support MP3, OGG, and WAV formats.

The mount manager 220 may detect that the input generator 210 has generated a malformed input through a predetermined signal input. When a preset number of malformed inputs are generated, the mount manager 220 may perform mounting on the generated malformed inputs so that a head unit controller of the head unit 120 of the vehicle may operate to recognize a malformed file located in at least one folder of the malformed-input storage unit 216 of the vehicle USB fuzzing apparatus 200 through a USB (see 160 or 240).

When the vehicle USB fuzzing apparatus 200 and the vehicle 100 are connected through a mounting operation of the mount manager 220 described above, the transmitter 230 may sequentially transmit a preset number of malformed inputs to the vehicle. In this case, the media player 140 which is a type of an application program of the head unit 120 may replay each malformed input.

The kernel log storage unit 250 may store kernel logs generated when the media player 140 replays each malformed input in the vehicle USB fuzzing apparatus 200.

While the vehicle USB fuzzing apparatus 200 performs fuzzing by directly transmitting a malformed input to the vehicle 100 outside the vehicle 100, the result checker 260 may monitor kernel logs generated during a fuzzing process and may check whether an error occurs in a USB-related log as a monitoring result. The result checker 260 may determine the success or failure of a fuzzing result based on the monitoring result of the kernel log.

In order to determine the fuzzing result, the result checker 260 may be configured to perform rebooting, for example, when the application such as the media player crashes. More specifically, for example, after a USB connection between the vehicle USB fuzzing apparatus 200 and an electronic control unit (ECU) of the vehicle 100 is disconnected, and the ECU is rebooted, the vehicle USB fuzzing apparatus 200 and the ECU may be reconnected through a USB.

In this case, a USB connection log may be generated in a buffer corresponding to the kernel log storage unit 250. The buffer may be configured to check a system boot message or record a message output from a kernel to a predetermined level according to a specific command of an operating system. The USB connection log stored in the buffer may include a diagnostic message log (dmesg log). In the USB connection log, a log of an application such as a media player may not be displayed. The vehicle USB fuzzing apparatus 200 may detect an error using the USB connection log.

Meanwhile, some ECUs may not be rebooted after being shut down by a software crash that occurs when a malformed input is replayed. In this case, the vehicle USB fuzzing apparatus 200 may detect an error using a mounting failure log stored in the kernel log storage unit 250 instead of the USB connection log.

On the other hand, in the above-described fuzzing process, the vehicle USB fuzzing apparatus 200 cannot accurately know a media file currently being replayed. That is, when a crash is detected, the vehicle USB fuzzing apparatus 200 cannot know which media file has caused the crush. In this case, the vehicle USB fuzzing apparatus 200 should replay media files one by one to find a file causing a crash, which complicates a fuzzing process. In particular, when there are a relatively large number of media files, for example, when the number of media files is tens of thousands or more, it may take a long time to find a file causing a crash.

Considering such issues, fuzzing may be performed by repeating a process of putting only one file storing in a folder for storing malformed inputs or malicious files to mount the folder, and then replaying the file. However, in that case, mounting and unmounting processes should be repeated according to the number of files used for fuzzing, and thus a fuzzing process is repeated too many times and becomes slow.

Therefore, in the present embodiment, 10 to 1000 malicious files, preferably about 100 malicious files, are stored in a folder during a unit or single fuzzing process, the folder is mounted on the vehicle 100, and then an application such as a media player of the vehicle 100 is allowed to execute the malicious files, thereby quickly and accurately performing a fuzzing process and a monitoring process of a fuzzing result. The preset number of malicious files used in a single fuzzing process may be somewhat different for each vehicle or each media player.

However, the reason for setting the number of malicious files described above is because when the number of malicious files used in a unit fuzzing process is less than 10, the fuzzing process may become complicated and too slow because mounting and unmounting processes should be repeated relatively too frequently, and when the number of malicious files is greater than 1,000, it may take a relatively long time to identify a file that has caused an error. In addition, the number of malicious files described above may be determined according to a situation when fuzzing is performed.

In particular, fuzzing the media player is not enough to test attacks through a USB port of the vehicle 100. Therefore, in the present embodiment, a raw gadget may be used to fuzz a USB. The raw gadget is a kernel module that implements a low-level interface for a subsystem of a USB device. The raw gadget may be used to emulate physical USB devices and virtual USB devices. A board including a USB device controller (UDC) may be provided to emulate a physical USB device, and a dummy UDC/host controller device (HCD) module may be provided to emulate a virtual USB device.

In order to fuzz a USB of a completed vehicle, that is, fuzz a USB kernel stack of the vehicle 100, the raw gadget of the present embodiment may use reproduction codes for bugs found in a Linux kernel USB stack as malformed inputs of fuzzing. The reproduction code may include something “crash01.log” or the like.

When the reproduction code is “crash01.log,” the reproduction code may be executed according to the following command by a component such as the transmitter 230 that performs file execution functions (execprog and executor).

“$ sudo ./syz-bin/syz-execprog -executor ./syz-bin/syz-executor -threaded=0 -collide=0 -procs=1 -enable=”-debug crash01.log”

In the above-described case, in executing the reproduction code, the transmitter 230 may perform a function similar to an existing Syzkaller.

FIG. 2 is a block diagram illustrating a structure of another input generator that may be adopted in the vehicle USB fuzzing apparatus of FIG. 1.

Referring to FIG. 2, an input generator 210a may include a seed input storage unit 212, a mutator 214, a malformed-input storage unit 216, and a crawler 218.

In the input generator 210a, the seed input storage unit 212, the mutator 214, and the malformed-input storage unit 216 are substantially the same as corresponding components described above with reference to FIG. 1.

The crawler 218 may collect a seed input or a reproduction code through a preset location or a preset network address online or on a network. The crawler 218 may include a program that searches a web for useful information and collects the useful information to the seed input storage unit 212 or a component that performs a function corresponding to the program. In the case of the present embodiment, the useful information may include a normal file or a seed file that may be used as a seed input.

When a collected reproduction code is stored in the seed input storage unit 212, the seed input storage unit 212 may be referred to as a reproduction code storage unit. In addition, when a mutated reproduction code is stored in the malformed-input storage unit 216, the malformed-input storage unit 216 may be referred to as a mutated-reproduction code storage unit.

In this way, in a vehicle USB fuzzing apparatus including the input generator 210a described above, when, after a seed input or reproduction code is collected from a designated site such as a preset website, the collected seed input or reproduction code is mutated to generate a malformed input or a mutated reproduction code, the malformed input or the reproduction code and/or the mutated malformed input or the mutated reproduction code is transmitted to a vehicle using a transmitter, and the malformed input, the reproduction code, the mutated malformed input, or the mutated reproduction code is replayed in the vehicle, a kernel log is monitored using a result checker to detect logs that occur under conditions such as media file playback failure or media player rebooting, thereby determining the success or failure of fuzzing based on the detected logs.

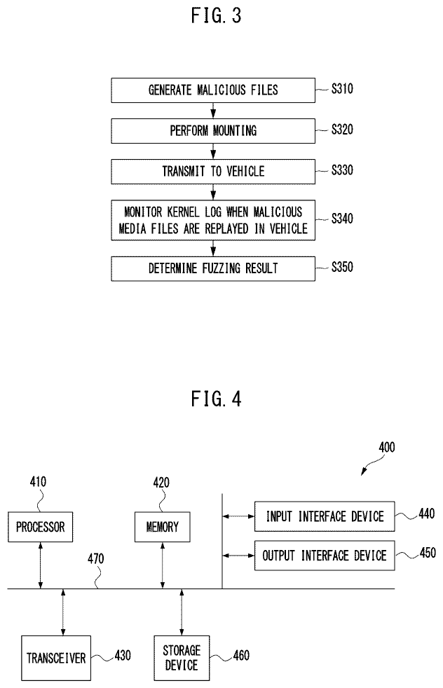

FIG. 3 is a flowchart of a vehicle USB fuzzing method according to another embodiment of the present disclosure.

Referring to FIG. 3, in the vehicle USB fuzzing method, first, normal media files such as seed inputs may be mutated using a mutator of an input generator to generate malicious media files to be used as a malformed input (S310). Of course, according to embodiments, the seed input may be replaced with a reproduction code.

Next, a mount manager may perform mounting to enable a vehicle to recognize malicious media files of a vehicle USB fuzzing apparatus. The mount manager allows a media player of a head device of a vehicle to recognize a malicious media file which is mutated through a USB gadget mode by an input generator and stored in a specific memory location or folder.

Next, a predetermined number of malicious media files may be transmitted to the vehicle through a transmitter (S330). The media player of the vehicle may replay the malicious media files. The predetermined number may be in a range of 10 to 1000, preferably, about 100. Of course, the number of malicious media files in such a single fuzzing operation may be adjusted according to a fuzzing target and/or a fuzzing situation.

Next, a result checker may monitor a kernel log that occurs when a malicious media file which is a malformed input is replayed in the vehicle, more specifically, when a USB connection is disconnected while the media player replays a malicious media file, and an error occurs (S340). In addition, the result checker may determine the success (pass) or failure of a fuzzing result based on a monitoring result.

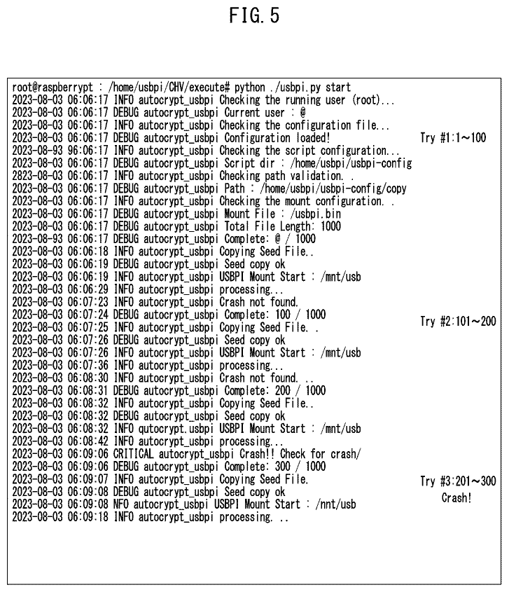

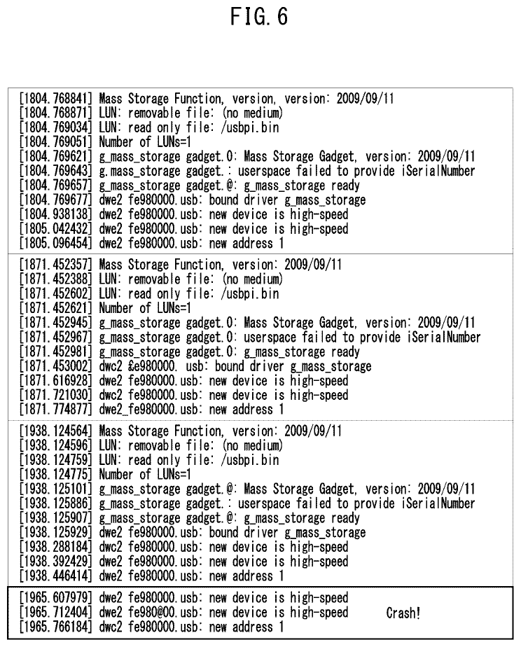

FIG. 4 is a schematic diagram of a structure of a vehicle USB fuzzing apparatus according to still another embodiment of the present disclosure. FIG. 5 is an exemplary diagram of a fuzzer log that may be used in the vehicle USB fuzzing apparatus of FIG. 4. FIG. 6 is an exemplary diagram of a diagnostic message (dmesg) log that may be used in the vehicle USB fuzzing apparatus of FIG. 4.

Referring to FIG. 4, a vehicle USB fuzzing apparatus 400 may include at least one processor 410, a memory 420, and a transceiver 430 connected to a vehicle network to transmit or receive signals or information. In addition, the vehicle USB fuzzing apparatus 400 may further include an input interface device 440, an output interface device 450, a storage device 460, and the like. Components included in the storage device 460 may be connected by a bus and may communicate with each other.

The processor 410 may be a central processing unit (CPU), a graphics processing unit (GPU), or a dedicated processor that performs methods according to embodiments of the present disclosure. Each of the memory 420 and the storage device 460 may include at least one of a volatile storage medium and a non-volatile storage medium. For example, the memory 420 may include at least one of a read-only memory (ROM) and a random access memory (RAM).

In addition, the processor 410 may execute a program command stored in at least one of the memory 420 and the storage device 460. The program command may include at least one command, and the at least one command may be included in a software module or a program. When the processor 410 operates, the processor 410 may be equipped with a software module or program that performs a function of each of an input generator, a mount manager, and a result checker.

In addition, the processor 410 may include a gadget file system for a low gadget mode. The gadget file system may be disposed between a user mode application and a gadget application programming interface (API) layer on a USB driver controller which is connected to hardware, and may be driven by a kernel subsystem and a gadget driver.

The transceiver 430 may include a transmitter and a receiver. The transmitter may be connected to an electronic device of a vehicle through a USB device and may transmit malicious inputs recognized by an application of the electronic device of the vehicle to the vehicle, that is, a corresponding application, through a mount manager. In addition, the transceiver 430 may further include a communication interface or sub-communication system for connection to a short-range wireless network or a universal base station through a wired or wireless communication network.

The input interface device 440 may include at least one selected from input units such as a keyboard, a microphone, a touchpad, and a touchscreen, and an input signal processing unit that maps or processes a signal input through at least one input unit according to a pre-stored command. In addition, the input interface device 440 may include a USB device. The input interface device 440 may acquire a kernel log from an electronic device of a vehicle connected through the USB device.

In this case, the result checker of the processor 410 may determine a result of the success or failure of fuzzing by checking whether an error appears in a USB-related log of the electronic device of the vehicle through the kernel log acquired while the fuzzing is performed. The kernel log may include the fuzzer log shown in FIG. 5 or the dmesg log shown in FIG. 6.

The output interface device 450 may include an output signal processing unit that maps or processes a signal output in the form of a prestored signal or at a level under the control of the processor 410, and at least one output unit that outputs a signal or information in the form of vibrations, light, or the like according to a signal of the output signal processing unit. The at least one output unit may include at least one selected from output units such as a speaker, a display device, a printer, an optical output device, and a vibration output device.

A vehicle media player fuzzing process using the vehicle USB fuzzing apparatus 400 described above is as follows.

First, the vehicle USB fuzzing apparatus 400 is set as a USB gadget.

Next, the vehicle USB fuzzing apparatus 400 generates a media file of an incorrect format in a preset or designated folder.

Next, the folder is mounted on a vehicle as a USB storage. An example of a Linux command for mounting the folder on the vehicle as the USB storage is as follows.

“$ sudo modprobe g_mass_storage file=/usb.bin stall=0 ro=1”

Next, while a media player of the vehicle retrieves and replays the media file in the folder, the vehicle USB fuzzing apparatus detects an error using a kernel log generated in the vehicle USB fuzzing apparatus.

Next, after all files in the folder are replayed, the folder is unmounted, and all files are removed. Thereafter, by returning to an operation of generating the media file of the incorrect format, a process of generating another media file of an incorrect format and subsequent processes may be performed.

Meanwhile, the vehicle USB fuzzing apparatus 400 having a configuration of a computing device described above may include a single board computer similar to a Raspberry Pi. In this case, an initial configuration of a USB gadget mode during the vehicle media player fuzzing process may be exemplified as shown in Table 1 below.

TABLE 1
[Basic Configuration]
Add dtoverlay=dwc2 to the /boot/config.txt
Add modules-load=dwc2 to the /boot/cmdline.txt
Just after the i2c-dev line dwc2 to the /etc/modules
[USB Storage]
sudo dd bs=1M if=/dev/zero of=/usb.bin count=2048 (2GB)
sudo mkdosfs /usb.bin -F 32 -I (FAT32)
sudo mkdir /mnt/usb_storage
Add /usb.bin /mnt/usb_storage vfat users,umask=000 0 2 to the /etc/fstab
sudo mount -a

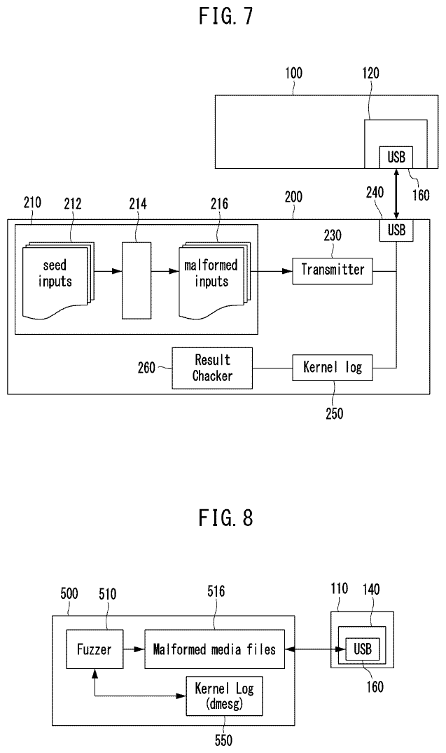

FIG. 7 is a schematic block diagram of a structure of a vehicle USB fuzzing apparatus according to still another embodiment of the present disclosure.

Referring to FIG. 7, a vehicle USB fuzzing apparatus 200 of the present embodiment may be connected to a head unit 120 of a vehicle 100 or a mounted USB port 160 mounted on the head unit 120 through a USB cable or the like. The head unit 120 may include an electrical component or an ECU and a controller therefor. In this case, the vehicle USB fuzzing apparatus 200 may fuzz a kernel area of the head unit 120 using a malicious file in which a system call message or the like has been mutated.

To this end, the vehicle USB fuzzing apparatus 200 may include an input generator 210, a transmitter 230, a USB interface 240, a kernel log storage unit 250, and a result checker 260. In the vehicle USB fuzzing apparatus 200 of the present embodiment, when fuzzing is not performed at a level of an application such as a media player, a mount manager may be omitted without being provided.

In order to fuzz the kernel area, the transmitter 230 of the vehicle USB fuzzing apparatus 200 may be a kernel fuzzer transmitter and may include a kernel module located in a mainline kernel as a kernel interface or low-level interface for USB device emulation. The kernel module may include a legacy gadget driver module.

The above-described kernel module may be used to emulate physical and virtual USB devices. In order to emulate a physical device, the kernel module may include a board on which a USB device controller is present. In addition, the kernel module may include a dummy USB device controller module to emulate a virtual device. The USB device controller or the dummy USB device controller is connected to a kernel that is being executed by the kernel module. Here, the kernel may refer to a type of an operating system of an abstract resource. It may be assumed that the USB device controller and a corresponding driver name are stored in the vehicle USB fuzzing apparatus or are readily acquirable by the vehicle USB fuzzing apparatus.

An operating process of the transmitter 230 may be configured to start, monitor, and restart a plurality of virtual machine (VM) instances. Such a process may start a process in a VM. In addition, the process may be executed in an unstable VM. Each process executes a single input, that is, a system call sequence. It is possible to accept a program to be executed in a process and send results again.

In this way, the vehicle USB fuzzing apparatus may perform fuzzing without a source code of a fuzzing target vehicle. That is, since fuzzing is performed without a source code in kernel area fuzzing, coverage measurement cannot be performed, but failure determination can be effectively performed by monitoring a kernel log of the vehicle USB fuzzing apparatus.

When existing seed inputs such as system call messages are mutated to generate more malicious inputs, the malicious inputs are transmitted to the head unit 120 of the vehicle 100 without a mount process, and then the transmitted malicious inputs are executed in the vehicle, the above-described vehicle USB fuzzing apparatus of the embodiment may be configured to determine a fuzzing result in a kernel area by monitoring a kernel log generated in the vehicle USB fuzzing apparatus. The malicious input corresponds to a malicious file.

FIG. 8 is a schematic block diagram of a part of a structure of a vehicle USB fuzzing apparatus according to yet another embodiment of the present disclosure.

Referring to FIG. 8, a vehicle USB fuzzing apparatus 500 may include a fuzzer 510, a file storage 516, and a log storage 550. The vehicle USB fuzzing apparatus 500 may include a single board computer.

The fuzzer 510 may be connected to the USB port 160 of an ECU 110 of a vehicle through a USB cable, may mount a predetermined number of malformed media files stored in the file storage 516 on an application 140 such as a media player installed in the ECU 110, and may determine a fuzzing result based on at least one kernel log stored in the log storage 550 when each of the malformed media files is replayed by the application 140.

The fuzzer 510 may include at least some components of an input generator, a transmitter, a mount manager, and a result checker or may be configured to perform a combination of functions thereof. The configuration or function of most of the components of this fuzzer 510 is substantially the same as or similar to that of corresponding components of the vehicle USB fuzzing apparatus described with reference to FIG. 1, and thus a detailed description thereof is omitted.

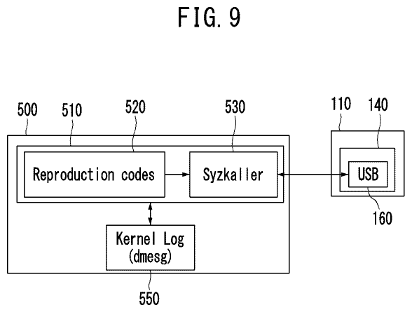

FIG. 9 is a schematic block diagram of a part of a structure of a vehicle USB fuzzing apparatus according to yet another embodiment of the present disclosure.

Referring to FIG. 9, a vehicle USB fuzzing apparatus 500 may include a fuzzer 510 and a log storage 550. In addition, the fuzzer 510 may include a code storage 520 and a syzkaller 530. In addition, the fuzzer 510 may be connected to a USB port 160 of an ECU 110 of a vehicle through a USB cable or the like.

The code storage 520 may store reproduction codes. The reproduction code may be preset by a crawler or the like and may be collected through an external server, a website, or the like connected through a network.

The log storage 550 may store a kernel log such as a dmesg log. The kernel log may be stored bey being generated due to an error or the like occurring at an application level or kernel level when a reproduction code is executed by a specific application 140 of the ECU 110 of the vehicle.

In the present embodiment, the syzkaller 530 may perform some functions similar to those of a previously known kernel fuzzer. That is, an existing syzkaller is an unsupervised coverage-based kernel fuzzer that is configured to perform an attack or testing on fuzzing targets (networks, file systems, files/media, or the like) that are classified as direct physical attacks, indirect physical attacks, local/remote wireless attacks, or the like. Meanwhile, in the syzkaller of the present embodiment, reproduction codes may be collected from a preset website, server, or node on a network, previously collected reproduction codes or mutated reproduction codes generated by mutating the collected reproduction codes may be sequentially replayed using the syzkaller 530 connected to a USB port 160 of the ECU 110 of the vehicle, and a kernel mode may be monitored during such a process to detect an error.

In particular, the vehicle USB kernel fuzzing apparatus of the present embodiment may be configured to diagnose a fuzzing result based on a kernel log related to rebooting, considering that a kernel is rebooted when crashes in all vehicles that are targets to be fuzzed. In this case, the vehicle USB kernel fuzzing apparatus may be configured to perform a single fuzzing operation on a preset number of files, for example, 10 to 1000 files, and preferably, 100 files.

In the above-described case, it is possible to quickly and accurately determine which reproduction code shows a successful fuzzing result among tens of thousands of reproduction codes for various models and multiple fuzzing target types, thereby significantly securing effects of shortening a fuzzing time and improving the convenience of a fuzzing operation.

The vulnerabilities according to vehicle USB fuzzing results confirmed through any one of the above-described vehicle USB fuzzing apparatuses of embodiments are as shown in Table 2 below.

TABLE 2

| No | Model | Type | CVE |
|---|---|---|---|
| 1 | Renault Zoe | Media player | ongoing |
| 2 | Renault Zoe | Media player | ongoing |
| 3 | Renault Zoe | Kernel | CVE-2023-39075 |
| 4 | Chevrolet Equinox | Media player | CVE-2023-28885 |
| 5 | Chevrolet Equinox | Kernel | CVE-2023-39076 |
| 6 | Volkswagen Jetta | Media player | CVE-2023-34733 |
| 7 | Volkswagen Jetta | Kernel | — |
| 8 | AGL | Media player | CVE-2022-48363 |

As shown in Table 2, the vehicle USB fuzzing apparatus may diagnose known common vulnerabilities and exposure (CVE) in a fuzzing target type for each vehicle model.

In Table 2, vehicle models include Renault Zoe, Chevrolet Equinox, Volkswagen Jetta, Automotive Grade Linux (AGL), and the like. The AGL is an open source project of the Linux Foundation that develops technologies related to the overall software building method of automakers and may refer to an existing vehicle infotainment system.

The fuzzing target type includes a media player, a kernel, and the like.

The CVE may be a term that refers to a list of publicly known computer security flaws and may include a unique notation for indicating publicly known security vulnerabilities in software in a vehicle. The CVE is a list of security vulnerabilities and other information security exposures, and each CVE is classified as a category-year-serial number. For example, CVE-2023-39075 may be 39,075th CVE registered with The Mitre Corporation (MITRE) in 2023 in a range of CVE in software.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A vehicle universal serial bus (USB) fuzzing method by a vehicle USB fuzzing apparatus connected to an in-vehicle infotainment (IVI) device through a USB, the vehicle USB fuzzing method comprising:
mutating a seed file in the vehicle USB fuzzing apparatus and generating malicious files;
performing mounting on the vehicle so that a head unit controller of the vehicle or an application of the IVI device recognizes the malicious files;
when the vehicle USB fuzzing apparatus is connected to the vehicle through the mounting, transmitting a predetermined number of the malicious files to the vehicle using a transmitter;
when the transmitting of the malicious files is completed, performing unmounting to disconnect the vehicle USB fuzzing apparatus from the vehicle;
monitoring a kernel log caused by the vehicle and generated in the vehicle USB fuzzing apparatus while media files, which are the malicious files, replay or are attempted to replay in the vehicle;
checking whether an error appears in a USB-related log in the monitoring of the kernel log; and
determining a success or failure of fuzzing based on the error of the USB-related log.

2. The vehicle USB fuzzing method of claim 1, wherein the generating of the malicious files includes randomly selecting several bits of the seed file and reversing the selected bits to generate the malicious files.

3. The vehicle USB fuzzing method of claim 2, wherein the several bits are bits in a range of 1% to 5% of all bits of each seed file.

4. The vehicle USB fuzzing method of claim 2, wherein the generating of the malicious files is performed to not change a file signature portion of the malicious file.

5. The vehicle USB fuzzing method of claim 1, wherein the performing of the mounting on the vehicle includes mounting a folder storing the malicious files on the vehicle as a USB storage.

6. The vehicle USB fuzzing method of claim 5, further comprising, when replaying of all of the malicious files in the folder is completed, unmounting the folder.

7. The vehicle USB fuzzing method of claim 1, further comprising collecting the seed file,
wherein the collecting of the seed file includes collecting a prestored reproduction code from a preset website or a preset address on a network.

8. The vehicle USB fuzzing method of claim 1, wherein the kernel log generated in the vehicle USB fuzzing apparatus is a mounting failure log of the head unit controller of the vehicle or the IVI device with respect to the malicious file.

9. The vehicle USB fuzzing method of claim 1, wherein the USB-related log is related to a log of the head unit controller of the vehicle, a log of the head unit controller of the vehicle when a kernel of the IVI device crashes, or a log regarding the IVI device being rebooted.

10. A vehicle universal serial bus (USB) fuzzing method by a vehicle USB fuzzing apparatus connected to an in-vehicle infotainment (IVI) device through a USB cable, the vehicle USB fuzzing method comprising:
mutating a system call message in the vehicle USB fuzzing apparatus and generating malicious files;
transmitting a predetermined number of the malicious files to a vehicle using a transmitter;
monitoring a kernel log caused by a USB device driver of an infotainment controller of the vehicle due to the malicious files and stored in the vehicle USB fuzzing apparatus;
checking whether an error appears in a kernel area-related log in the monitoring of the kernel log; and
determining a success or failure of fuzzing of a kernel area of an infotainment device or an electronic control unit of the vehicle based on the error in the kernel area-related log.

11. A vehicle universal serial bus (USB) fuzzing apparatus connected to an in-vehicle infotainment (IVI) device through a USB cable, the vehicle USB fuzzing apparatus comprising:
an input generator configured to mutate a seed file in the vehicle USB fuzzing apparatus and generating malicious files;
a transmitter configured to transmit a predetermined number of the malicious files to a vehicle; and
a result checker configured to monitor a kernel log caused by the vehicle due to the malicious files and stored in the vehicle USB fuzzing apparatus, check whether an error appears in the monitoring of the kernel log, and determine a success or failure of fuzzing based on the error.

12. The vehicle USB fuzzing apparatus of claim 11, wherein the input generator randomly selects several bits of the seed file and reverses the selected bits to generate the malicious files.

13. The vehicle USB fuzzing apparatus of claim 12, wherein the several bits are bits in a range of 1% to 5% of all bits of each seed file.

14. The vehicle USB fuzzing apparatus of claim 12, wherein the input generator performs the mutation to not change a file signature portion of the malicious file.

15. The vehicle USB fuzzing apparatus of claim 11, further comprising a mount manager configured to perform mounting on the vehicle so that a head unit controller of the vehicle or an application of the IVI device recognizes the malicious files.

16. The vehicle USB fuzzing apparatus of claim 15, wherein the mount manager causes a folder storing the malicious files to be mounted on the IVI device of the vehicle as a USB storage.

17. The vehicle USB fuzzing apparatus of claim 16, wherein the mount manager unmounts the folder when the transmission of the malicious file is completed or when replaying of all of the malicious files in the folder is completed.

18. The vehicle USB fuzzing apparatus of claim 11, wherein the input generator further includes a crawler configured to collect a prestored reproduction code from a preset website or a preset address on a network.

19. The vehicle USB fuzzing apparatus of claim 11, wherein the kernel log generated in the vehicle USB fuzzing apparatus is a mounting failure log of a head unit controller of the vehicle or the IVI device with respect to the malicious file.

20. The vehicle USB fuzzing apparatus of claim 11, wherein the seed file includes a system call message, and
the kernel log includes a log of a head unit controller of the vehicle, a log of the head unit controller of the vehicle that occurs when a kernel of the IVI device crashes, or a log regarding the IVI device being rebooted.
